(19) United States
(12) Patent Application Publication
(10) Pub. No.: US 2022/0397975 A1
(43) Pub. Date: Dec. 15, 2022

(54) METHOD, APPARATUS, AND COMPUTER PROGRAM FOR TOUCH STABILIZATION

(71) Applicant: Bayerische Motoren Werke Aktiengesellschaft, Munich (DE)

(72) Inventor: Etienne ILIFFE-MOON, Menlo Park, CA (US)

(21) Appl. No.: 17/343,080

(22) Filed: Jun. 9, 2021

(51) Int. Cl. G06F 3/041; G06F 3/0488; G06F 3/0482; G06F 3/01

(52) U.S. Cl. CPC G06F 3/0418; G06F 3/04886; G06F 3/0482; G06F 3/013; G06F 2203/04108

(57) ABSTRACT

Embodiments relate to a method, apparatus, and computer program for stabilizing a user's interaction with a touchscreen in a vehicle. The method comprises populating an interface of the touchscreen display with a plurality of elements. Each element of the plurality comprises an active area for registering a touch interaction by the user. The method further comprises determining a focus area of the user on the interface and comparing the focus area with the active areas of the plurality of elements to determine a focused set comprising at least one element that exceeds a likely selection threshold. The method continues by adjusting the active areas of the plurality of elements to reduce the likely selection threshold of at least one element in the focused set.

### FIELD

Embodiments relate to a method, apparatus, and computer program for stabilizing a user's interaction with a touchscreen in a vehicle.

### BACKGROUND

Vehicles are increasingly equipped with fewer physical controls while incorporating more touch-supported or touch-only interfaces into their cabins. In certain vehicle seating configurations (e.g., zero gravity or lie-flat seats), a touchscreen interface may be preferred over physical interfaces. However, conventional touchscreens in dynamic automotive applications may not provide a method to stabilize a user's finger or hand when interacting with the touchscreen. This creates safety issues when the user is driving because the user may split their focus between the road and a digital display. Furthermore, the lack of hand stability is amplified by the interior design and cockpit layout of vehicles that place a touchscreen at arm's length or further away from the user when compared to non-vehicle environments. Hence, there may be a desire for improved methods and apparatuses for stabilizing a user's interaction with a touchscreen in a vehicle.

### SUMMARY

Embodiments relate to a method, system, and computer program for stabilizing a user's interaction with a touchscreen in a vehicle. According to an embodiment, a method for stabilizing a user's interaction with a touchscreen comprises populating an interface of the touchscreen display with a plurality of elements. Each element of the plurality comprises an active area for registering a touch interaction by the user. The method further determines a focus area of the user on the interface and compares the focus area with the active areas of the plurality of elements to determine a focused set of interface elements. The focused set comprises at least one element that exceeds a likely selection threshold. The method adjusts the active areas of the plurality of elements to reduce the selection threshold of at least one element in the focused set and thus increase the likelihood of selection.

Embodiments of the method use eye gaze to increase the target or active area of buttons, icons, interactive elements, or other features of the graphical user interface (GUI) that the eye is focused on. This allows room or leeway for increased imprecision (i.e., mistouch) by the user's finger. The objective is to adapt the GUI for imprecise touch in dynamic environments, such as a moving vehicle. Other objectives include increasing touch accuracy and success, reducing driver distraction from the road, and increasing the user's confidence and perception of ease of use. The method stabilizes a user's selection by predicting what elements they are likely to select and increasing their likelihood of selection. For example, one might consider eye gaze tracking as acting a little like a flashlight or magnifying glass that increases the size of the active area or target zone for GUI buttons as the eye gaze moves over the GUI. The size increase of the target zone may be invisible or visible to the user.

A vehicle may be land-, sea-, or air-based. It may include any apparatus used for transportation. Additionally, the method, system, and computer program are vehicle independent and may be deployed in environments and systems not used or designed for transportation, such as in a home, a retail environment, public spaces, an office.

A touchscreen may be a digital display with capacitive or similar touch properties. The display may be an electroluminescent (ELD), liquid crystal (LCD), light-emitting diode (LED), thin-film transistor, organic LED (OLED), active-matrix OLED (AMOLED) plasma (PDP), quantum dot (QLED), cathode ray tube, or segment displays. The display may have additional properties such as presence detection, acoustic, or infrared touchscreen properties.

The method may apply to touch-sensitive surfaces that are not displays (e.g., capacitive or resistive sensitive surfaces that do not have a pixel-based display beneath). In a vehicle, this may be a touch-sensitive console that displays permanent, frequently-used buttons like those of the car's climate control systems or door locks. These touch-sensitive surfaces may work alone or remotely in conjunction with a non-touch display or touch-screen display. This method may also apply to a projected display with touch or gesture interaction (e.g., GUI is projected onto an ambient surface or user's body/hand).

Elements of the touchscreen interface can be any digital media that is a static or moving image (e.g., GUI, rendered 3D object, motion graphics animation, photo image, movie, etc.). An active area, sometimes called a target area, may be a property of an interface element that allows for interaction with the element. It is the area or field on or around a GUI element (e.g., button, icon, feature) that when touched will cause the GUI element to be activated (e.g., the button/icon is clicked). The active area is sometimes identical to the visual shape of the element as it appears on the screen but is independent of its visual appearance. For example, many irregular-shaped interface elements comprise a rectangular active area that allows for ease of interaction. So, when a user attempts to select an irregular element, they are not required to touch within the visual borders of the element but can, rather, select the element by touching within its larger and more convenient active area. The target or active area is often hidden from the user; however, its presence may be indicated in various ways. For example, an active area may be highlighted as the user's finger approaches the element or screen. Or the active areas may be shown to the user visually, for example, through subtle visual indication or with a brief animation.

Users of conventional touchscreens in vehicles often split their focus between the road and the screen while they confront a changing environment with road vibrations and momentum changes. Often this results in a jabbing behavior as the user repeatedly hunts for the interface element they want unsuccessfully. By stabilizing the user's touch interaction, the user may have a safer and more productive experience as their focus is split for a shorter period and their selection is more likely to be chosen. Additionally, stabilizing the user's touch interaction may aid users with unsteady hands or those that are visually impaired by making it easier to select user interface elements.

Conventional technological solutions for stabilization include using force-touch touchscreen technology (e.g., when the user presses with their finger, finds the target, holds, then releases the finger to select) or physically using the touchscreen to stabilize the finger before “zeroing” on the UI target button. However, these conventional solutions require a moment of eye fixation or dwell time that that creates further problems with divided focus and selection delay. Other solutions, such as using a confirmation prompt or a physical accept button (e.g., on the steering wheel) have similar problems and are not immediately intuitive. Additionally, using a different modality to eliminate the need to interact with the touchscreen—such as voice interaction—may increase the cognitive load of the user as they now must recall menu options and proper phrasing. The user may also be required to alter the environment of their vehicle, such as turning down music or rolling up windows, to increase the success of the new modality. Therefore, predicting where a user's selection will occur and activating the selection upon contact (or soon after) with the touchscreen may allow for stabilization to be accomplished while reducing focus time and selection delay compared to conventional solutions. The disclosed embodiments work to too “smooth” out this interaction process by utilizing user tracking technology, such as eye-tracking (i.e., gaze tracking) or finger tracking.

Conventional solutions that use eye-tracking technology, may require the user to manipulate a separate device, such as a remote, to select elements on the screen. Here the eye-tracking or eye gaze may be used as an aid to the remote rather. A remote controller may have an engaged state (e.g., when the device is held in hand or touched) and an active state (e.g., touchscreen receives a touch input). In these solutions, eye gaze provides a secondary influence when the remote controller is used to navigate the GUI elements. Perhaps providing haptic feedback to influence how the remote is manipulated. However, these solutions may not be appropriate for a vehicle environment as prolonged manipulation of a remote or the experience of haptic feedback may distract a driver and keep their attention off the road. Generally, in a vehicle environment, all feedback should be to confirm a successful interaction.

In the main embodiments, eye tracking may be the primary modification or adjustment to the active areas for each GUI element. The user's touch input may be secondary to the modification and should not override eye gaze. The user's eye gaze may increase the active area of the GUI button or other element that the eye focuses on. Only if the user is not looking at the display (i.e., blind touch by the user) is the eye gaze overridden or discarded. In a blind touch situation, the user touches the display without looking at it or touches it and then looks at the display. This method accommodates that possibility as the GUI will operate at its default touch zone setting (e.g., the active areas match the size of the GUI button or element).

The method may further determine a physical area corresponding with the user's interaction with the touchscreen and determine a touch target by comparing the physical area with the active areas of the focused set. The method may then select one of the plurality of elements based on the touch target. By incorporating the physical interaction of the user with the touchscreen error correction and more accurate stabilization can be carried out and confidence can be increased. A physical area may be as small as a point representing the point of contact the user had with a screen. It also may be larger, for example representing a wider contact area at the moment of contact (i.e., the width of a fingertip) or representing a series of contact points made soon after contact (i.e., the path or area of a finger drag across the screen). In the latter case, a user may drag their finger across the screen intentionally, as a correction mechanism by using the touchscreen to brace their finger. It also may be unintentional, because of a change in momentum or ride quality in a vehicle. The method may consider these factors and modify the size of the physical area based on external factors, being more lenient (e.g., increasing the size of the physical area) when a rougher ride is detected. Or the method may choose the last point in a series or path as the physical area if the user drags their finger across the screen, exceeding a distance threshold.

When a user interacts with a GUI on a touchscreen through a touch gesture (e.g., single or multi-touch, swipe, pinch, zoom, etc.) there is a cognitive and physical process that the user goes through to interact with a GUI element such as a menu or button. In a simplified example, a user typically initiates an interaction with a touchscreen by first looking at the display, identifying the target GUI element (e.g., button), reaching out, and locating the button in a proprioceptive feedback loop that eventually results in successfully activating that button. However, in a dynamic driving situation, the proprioceptive process of locating and activating the button can be a difficult process that requires cognitive and physical effort, which in turn increases the load on the user (e.g., a cognitive load, attention load, physical load, etc.).

Physically, the size of the screen and the user's reach may affect the accuracy of a user's touch interaction. Typically, the accuracy of touch decreases with extent/distance of reach (e.g., when their arm is stretched strength, stability, proprioception, gaze diversion from the road, etc. becomes more challenged). This increased load consequently increases the safety risk when the user is driving by diverting attention away from the task of driving.

The method may further comprise averaging the physical area with the active areas of the focused set to determine which element of the focused set is the touch target. When a physical interaction is made (i.e., a physical area is determined) it may be weighed against the elements of the focused set. For example, if the physical area is within the focused set, it may be weighted highly and cause the selection of the element to be executed. However, if the physical area is outside the focused set its location may be averaged with the focused set to find a third location for selection. For example, this may be the nearest element or active area in the focused set to the physical area, an element halfway between the center of mass of the focused area and the physical area (for example, this may be done when the focused set and physical area are large or irregular shapes), or some other calculation known to persons skilled in the art.

The method may further comprise delaying the selection of the touch target until the physical area is realigned with an active element of the focused set. If the physical area is outside the focused set the method may allow the user an opportunity to correct their selection by realigning (e.g., by dragging) their finger to an element of the focused set. The system then allows the user to select an item within the focused set rather than inadvertently selecting an element outside of the focused set that corresponds with the physical area.

Adjusting the active areas may include adjusting the size of the active areas, moving the active areas, or visually highlighting the active areas. By adjusting the size of the active areas, the elements of the graphic user interface may have a larger selection target without changing the visual size of the elements on the interface. This allows for a consistent visual user experience while allowing the user to select an element without landing on its exact visual location or representation. Furthermore, the size increase of the active area may be proportional to the eye gaze dwell time. Increasing the active area for the button or other GUI element should increase the success rate for activating the desired element on the first try of the user and increase the user's confidence in the system.

Highlighting the active area may also help the user stabilize their touch interaction by giving them an obvious landing area to physically interact with. Additionally, moving the active areas may also allow the user to select an interface element that they may intend to target by cannot easily reach, particularly in vehicles where the touchscreen is further than an arm's length from the user.

Increasing or otherwise adjusting the target interactive area of a button, icon, or other feature of a GUI may be invisible or visible to the user. For example, if the adjustment is invisible the target area increases whereas the graphic representation of it would not. If the adjustment is visible, the representation of the graphic element or feature would be modified to signal an increased target area. Both the target area and the button, icon, or other elements may be modified to change in size or shape simultaneously. Moreover, if both the invisible target area and the visible graphic representation of an element are adjusted, their adjustments might not be identical. For, example the invisible target area may enlarge to a greater degree than a visible enlargement of a button.

Determining a focus area may comprise tracking the user's eyes using the eye-tracking apparatus. Eye-tracking technology (e.g., frame rate, resolution, combined RGB and IR, etc.) has steadily increased in accuracy and now allows tracking the foveal view with reliability. Machine learning may increase this accuracy further, as the model of gaze (action) and touch (input) provides data to train the machine learning model.

The method may include determining an orientation or gaze of the user's eyes with respect to the touchscreen. The orientation of the user's eyes corresponds to a first physical location of the touchscreen. The method may further comprise measuring a focus time that the user's eyes occupy the orientation and calculating the focus area on the touchscreen based on the orientation of the eyeball and focus time. Using the user's gaze to determine the focus area may reduce the cognitive and physical load on the user (i.e., driver) when interacting with a touchscreen whilst driving. The time it takes to comprehend and physically interact with a touchscreen is the time that the user's attention is diverted from the road. This presents a safety risk.

When weighing multiple factors to determine a focused set, a user's gaze should generally come before touch. This is because touchscreens do not provide a physical affordance to stabilize the user's finger or hand in the same way that a physical button does. Further, in a cognitive process, the user first identifies the GUI target visually and then attempts to touch the target GUI element. This creates an order that prioritizes the user's visual identification of a GUI element over their physical one. This process with a conventional touchscreen in a car can take time and effort. In a dynamic and moving vehicle (e.g., with road bumps, cornering, etc.) it may be demanding, difficult, and fatiguing to reach out the arm, hand, and finger to touch a point at arms reach (e.g., at approx. 25 to 27 inches). Further, these factors make it difficult to make an accurate touch selection of a GUI button without physically stabilizing the hand and/or finger.

The method may further comprise a finger-tracking apparatus that tracks the user's at least one figure. The orientation of the user's at least one finger corresponds to a second physical location of the touchscreen. The method may include calculating the focus area on the touchscreen based on the orientation of the user's at least one finger. By optionally complementing the eye-tracking with added hand or finger tracking (e.g., capacitive touch-sensing, TOF camera, camera with skeletal modeling, lidar, etc.) a feedback loop is created allowing for more accurate predictions, error correction, and interface adjusting. Additionally, combining gaze and finger tracking can provide additional GUI adaption possibilities.

The method may further comprise calculating the focus area on the touchscreen until a physical area corresponding with the user's interaction with the touchscreen is registered or determined. By refining the focus area as the user approaches the touchscreen the active areas can be dynamically adjusted based on more up-to-date gaze and finger tracking.

In another embodiment, the method may be executed by a system for stabilizing a user's interaction with a touchscreen. The system may comprise a touchscreen, an eye-tracking apparatus, and a processor. The processor may be configured to populate an interface of the touchscreen display with a plurality of elements, wherein an element of the plurality comprises an active area for registering a touch interaction by the user. The processer may further determine a focus area of the user on the interface and compares the focus area with the active areas of the plurality of elements to determine a focused set comprising at least one element that exceeds a selection threshold. Then the processor may adjust the active areas of the plurality of elements to increase the selection threshold of at least one element in the focused set.

Additionally, a machine learning approach can help the system learn from eye gaze behavior and interaction behavior. This may allow for calibrating the system for a driver, learning from patterns to predict behavior, and other machine learning benefits. A machine learning approach may allow for context understanding to understand or recognize patterns and make predictions based on a user, vehicle, or GUI context. Machine learning can also aid with the calibration of the system for different users or drivers. Further, a combination of gaze focus and finger approach may allow for a statistical evaluation of the interaction data. For example, the dimensional and time-based relationship between the point of gaze and touch. Or, in another example, the learning based on the success of interaction (e.g., after an interaction, determining whether a user continues to progress in a known process or determining whether a user repeats a step or backtracks due to a mistouch, incorrect entry, or exploring, etc.) The system may also determine the frequency of interaction a user has with a touchscreen or its interface elements. Tracking frequency of interaction may inform which elements of the interface are more likely to be selected by a user so that these elements are weighted to increase their likelihood of selection. This may be done for individual users so that similar patterns of touch interaction (e.g., a similar focus area and physical areas) may be weighted differently based on the recorded frequencies of different drivers.

In some embodiments, the stabilization may take advantage of proximity touch (i.e., detection of a finger as it approaches a display. Utilizing a machine learning approach and combining past data patterns on gaze and touch behavior, the system may have an optional feature (e.g., selected by user preference, or automatically activated) to predictively activate a GUI element before the actual moment of touch (e.g., behaving as mid-air or proximity touch gesture). In a further embodiment, stabilization may use 3D finger tracking to enable an understanding of proprioceptive “zeroing-in” behavior as the user extends their hand, reaches, and touches the display. Zeroing-in behavior is a common underlying reason for the “click on release” button action that is common for GUIs, as it allows users to error correct. This can also provide a “hover” feature (e.g., the user can pause and hover finger above touchscreen or move a finger across the user interface, such that different GUI elements respond as the user hovers and moves a finger across the GUI screen (e.g., to provide previews, tips or further info as is common in GUI practice).

The eye-tracking apparatus of the method or system may comprise an infrared camera or a headset. The eye-tracking apparatus may include head tracking, face tracking, or eye-tracking. Tracking a user or viewer's eye may result in a highly accurate estimate of the viewer's viewing angles to accurately adjust the holographic display. Head or face tracking may also produce a similar result with less expensive or specialized equipment.

Determining the focus area of the user on the interface may comprise tracking the user's eyes using the eye-tracking apparatus and determining an orientation of the user's eyes with respect to the touchscreen. The orientation of the user's eyes may correspond to a first physical location of the touchscreen. The processor may further measure a focus time that the user's eyes occupy the orientation and calculate the focus area on the touchscreen based on the orientation of the eyeball and focus time.

The system may comprise a finger-tracking apparatus that tracks the user's at least one figure. The orientation of the user's at least one finger may correspond to a second physical location of the touchscreen. The processor may further calculate the focus area on the touchscreen based on the orientation of the user's at least one finger.

The eye-tracking apparatus may include head tracking, face tracking, as well as eye-tracking features. Tracking a user or viewer's eye may result in a highly accurate estimate of the viewer's viewing angles to accurately adjust the active areas. Head or face tracking may also produce a similar result with less expensive or specialized equipment. The system may include an occupancy sensor. Using an occupancy sensor may enable more accurate apparatus adjustments than a measurement device alone. For example, if a vehicle only has an eye or head tracking camera for the driver, using an occupancy sensor for a passenger seat may allow the apparatus to be adjusted for a passenger and a driver if a passenger is detected.

The touchscreen may be located in the vehicle's armrest, pillar, dashboard, bonnet, headliner, or console. The nature of touchscreens allows for the non-traditional placement of a screen compared to conventional displays. Furthermore, placing the touchscreen in an armrest, pillar, headliner, or another area of a vehicle can make use of space that is non-traditionally used and that presents stabilization problems for conventional touchscreens.

Implementations of the described techniques may include hardware, a method or process, or computer software on a computer-accessible medium. Other embodiments of this aspect include corresponding computer systems, apparatus, and computer programs recorded on one or more computer storage devices, each configured to perform the actions of the methods. Implementations of the described techniques may include hardware, a method or process, or computer software on a computer-accessible medium.

### BRIEF DESCRIPTION OF THE FIGURES

Some examples of apparatuses and/or methods will be described in the following by way of example only, and with reference to the accompanying figures, in which:

FIG. 1 shows a block diagram of a method for stabilizing a user's interaction with a touchscreen.

FIG. 2 shows an embodiment of the system for touch stabilization.

FIGS. 3A to 3C shows an illustrative example of eye gaze tracking between a plurality of interface elements.

FIG. 4 shows a schematic view of the system for touch stabilization in a vehicle.

FIG. 5 shows examples of adaption of active areas of an interface element.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to the same or similar elements and/or features, which may be identical or implemented in a modified form while providing the same or a similar function. The thickness of lines, layers, and/or areas in the figures may also be exaggerated for clarity.

When two elements A and B are combined using an ‘or’, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components, and/or a group thereof, but do not exclude the presence or addition of one or more other features, integers, steps, operations, processes, elements, components and/or a group thereof.

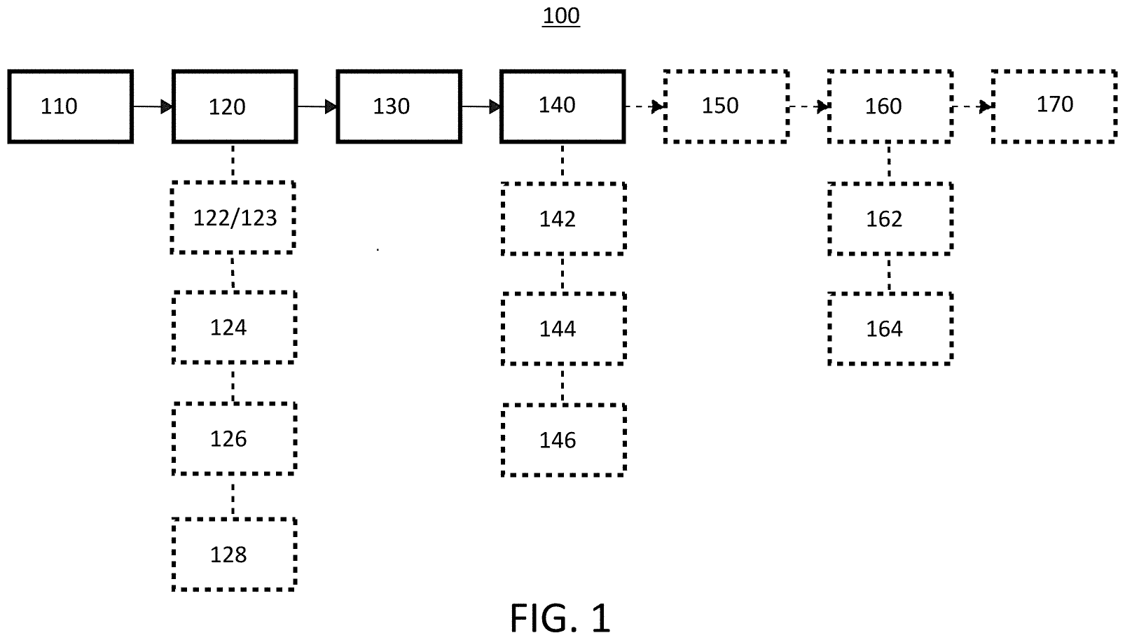

FIG. 1 shows a block diagram for a method 100 for stabilizing a user's interaction with a touchscreen. The method 100 comprises populating an interface 110 of the touchscreen display with a plurality of elements (i.e., GUI elements), wherein an element of the plurality comprises an active area for registering a touch interaction by the user. The method 100 further comprises determining a focus area 120 of the user on the interface and comparing the focus area 130 with the active areas of the plurality of elements to determine a focused set comprising at least one element that exceeds a likely selection threshold. The method 100 then comprises adjusting the active areas 140 of the plurality of elements to reduce the likely selection threshold of at least one element in the focused set.

Generally, a user's focus area is determined by observing and measuring the gaze of one or both eyes. Although to further refine the focus area determination, other measurements may be optionally included (e.g., the location of their finger before contacting a display). Eye gaze tracking (e.g., high accuracy gaze tracking, such as through a high resolution, fast frame rate camera) uses eye gaze fixation data to dynamically expand the active area or target zone of a GUI element (e.g., button, slider, etc.). Expanding the active area makes it easier for the user to select that specific GUI element. In other words, expanding an active area requires less accuracy, attention, and effort from a user to successfully use a touchscreen.

After determining that the user intends to interact with an interface, the method 100 first determines a focus area 120 on the interface. A focus area may be, at minimum, a point but it may be any 2D shape that the user is aiming at. It may, generally, be a circle where the radius or diameter is dependent on the accuracy and precision of the technical solution or measurement apparatuses (e.g., camera resolution and software to calculate position). The method 100 then compares the focus area with an active area of one or more interface elements and selects one of the one or more interface elements if the focus area (e.g., foveal fixation) and active area exceed a selection threshold. Optional steps may include expanding the size and/or modifies the shape of the active area or trigger zone of the GUI element. Altering the active area may not be visible to the user and purely a determination by the system. Altering the active area may; however, correspond with a substantially identical adjustment of the GUI elements to visually indicate a changed interface that renders some elements easier to select.

In some embodiments, there might not be an actual selection of an interface element. The GUI element may be modified in some way, such as through highlighting, growing (e.g., to express the change in trigger zone), or by other means known in the art.

In some embodiments, the method awaits physical contact with the display before altering active areas of GUI elements. The method 100 then determines a focus (i.e., where the user intends to aim) area on the interface (at minimum a point but it may be any 2D shape) that the user is aiming at and compares the aim area with an active area of one or more interface elements. The method 100 then selects one or more interface elements if the aim area and active area exceed a match threshold. After selection, the method 100 adjusts the active area of the one or more selected interface elements to increase the probability that they are selected by physical interaction with the display;

The method 100 may further comprise determining a physical area 150 corresponding with the user's interaction with the touchscreen. Then determining a touch target 160 by comparing the physical area with the active areas of the focused set. And finally, the method 100 includes selecting 170 one of the plurality of elements based on the touch target.

When the system registers a physical interaction with the display, the method 100 determines a physical area (at minimum a point but it may be any 2D shape) corresponding to the physical input. The method 100 then selects one of the one or more adjusted active areas of the interface elements if the physical area and active area exceed a selection threshold. The selection threshold may include selecting an element if the area of touch contacts (e.g., touches, overlaps) or is proximal (e.g., closer to that element than any other element or within a certain threshold.

Physical interaction with a touchscreen using finger contact is a dynamic thing. A user's hand is often not stable, particularly in a vehicle environment. Moreover, users often move their hands or finger as they are trying to decide. Users often touch and think at the same time, such that it is better from a GUI design perspective to register an action (e.g., a button press) when the finger is removed rather than on the first touch. This is known as click-on-release.

Determining the touch target 160 may comprise averaging 162 the physical area with the active areas of the focused set to determine which element of the focused set is the touch target. Determining the touch target 160 may also comprise delaying 164 selection of the touch target until the physical area is realigned with an active element of the focused set.

In some embodiments, if the method 100 determines that the user intends to interact with an interface, the method 100 first determines a focus area 120 on the interface that the user is aiming at. The method 100 then determines a physical area on the interface corresponding to a received physical input and weighs the aim area and the physical area based on confidence values for each. Next, the method 100 determines the focus area using the weighted values of aim and physical areas, selects the one or more interface elements based on the focus area;

Determining a focus area 120 may comprise tracking the user's eyes 122 using an eye-tracking apparatus, then determining an orientation of the user's eyes 124 with respect to the touchscreen. The orientation of the user's eyes may correspond to a first physical location of the touchscreen. Determining a focus area 120 may further comprise measuring a focus time 126 that the user's eyes occupy the orientation and calculating the focus area 128 on the touchscreen based on the orientation of the eyeball and focus time.

Tracking the orientation of a user's eyes or eye gaze, primarily comprises determining the position of the user's iris. However, this may include other factors such as monitoring the arrangement or orientation of other facial features. The orientation of the pupil/eyeball when a user fixates on a point or object is independent of the head/face orientation (assuming the tracking system is static (mounted in the cabin, close to or on the touchscreen) and not tied to the head).

The makeup of each factor in determining the gaze may be adjusted in different scenarios. The human eye does not move smoothly but darts from place to place in what is known as a saccade. The eye saccade helps with determines a user's gaze because it gives us a more defined fixation position/value. However, when the eye fixates, it does tend to drift slightly (e.g., 1/10th of a degree), which a person of ordinary skill can account for. When a measurement device, such as an IR camera, is fixed in the environment, the method 100 can better determine if the user is looking at a display and not, for example, the cupholder. This is because the relative placements of the camera and touchscreen are known. To determine fixation on specific GUI elements, once an element is viewed the method determines fixation based on a time threshold and mean position (to account for saccade and drift). Further, eye fixation and finger touch may be compounded at the moment of contact with a touchscreen (e.g., the user's eye fixates on a button as their finger zeroes in on that button). A user's visual and cognitive attention (and maybe “proprioceptive” attention with the action/control of the finger) come together more substantially at that time.

In some embodiments, if a user changes their focus between the road and display information about the user's intent may be gleaned (e.g., that eye behavior would be different when one is trying to comprehend a GUI and find a button versus glancing occasionally at a map.

Determining a focus area 120 may further comprise tracking the user's at least one finger 123 using a finger-tracking apparatus. The orientation of the user's at least one finger may correspond to a second physical location of the touchscreen. The calculation of the focus area 128 on the touchscreen may further include the orientation of the user's at least one finger. In a further embodiment, calculating the focus area on the touchscreen 128 may continue until a physical area corresponding with the user's interaction with the touchscreen is determined 150.

In some embodiments, an RGB camera(s), IR camera(s), or Lidar-based sensor to track hand and finger location. As known in the art, many systems model finger joints and understand skeletal orientation and position. In some instances, 3D finger tracking may not provide enough resolution to accurately detect touch contact. Therefore, the combination of other technologies may make up for any deficiencies. Capacitive sensing may be used to sense touch and can also be tuned to give pressure and proximity.

In some embodiments, the method 100 may distinguish between multiple users. For example, a driver who is looking at the display but a passenger doing the selection. In this embodiment, the method may discount the driver's gaze. The method may also focus on the gaze of a passenger and adjust the targets for the passenger, particularly if multiple users are covered by a single camera or multiple cameras. Further, when both eye and hand tracking is performed, the method may tie together the hand and the eye so that they belong to the same user (passenger or driver). This may be accomplished by looking at hand orientation or looking more completely at the user.

In some embodiments, there may be a large or shared display (e.g., pillar to pillar or center information display (CID)) which can be used by multiple people (e.g., a driver and passenger) simultaneously. The method 100 may also include touch stabilization for each user, based on the eye gaze of each user and associating each user's gaze with the fingers or hands of that user.

When the method 100 is executing, it does not necessarily prevent the touchscreen from working normally. One of the results of gaze fixation is to expand the trigger zone of the GUI element, it does not necessarily need to reduce the trigger zone of the other GUI elements. In other words, the trigger zones across the GUI remain accessible for the user or anyone to use. For example, if a user looks at the top right corner of a display and their finger was hovering near the bottom right, the method may focus on expanding the trigger zone for what the eye is fixated on. However, the rest of the touchscreen may still be interacted with normally (i.e., without augmented active areas). Therefore, it is the GUI element that the user touches and activates (i.e., click-on-release) that determines the result of the interaction. Focus areas determined by eye gaze supports the interaction.

In scenarios where the user may touch the display blind (i.e., without looking at the touchscreen, for example, when their eyes are fixed on the road) and by memory. The method 100 may use previously known information about the user's habits or simple frequency metrics to trigger a default state. This state may expand the active area of the most used or most probable interface elements.

In some embodiments, measuring the proximity of the finger to the fixation point may scale the amount that the active area is increased. This scaling may be limited to a threshold or relative to the other GUI elements and their active areas. For example, the active area of a GUI element that is selected due to the eye gaze focus area may expand up to the active areas of adjacent GUI elements. The active areas of the focused element may also overlap other GUI elements to a limited degree that does not completely override the other GUI elements.

Often, a user's cognitive intent (i.e., what a user is thinking) is reflected subsequently or follows shortly afterward by what a user looks at (i.e., a user's visual attention or fixation. What a user looks at after an action can reveal if the assumptions about the fixated elements were good or not. For example, if a user looks for or at a back button (i.e., the user has made an erroneous selection) then the assumption about the fixation may have been a mistake. Conversely, if a user looks at the expected next steps (e.g., a user selects a music album and then presses play or selects a track) then the assumption about the fixation may have been correct.

In an embodiment, ambiguity in the selection of a GUI element may be prevented by ensuring the touch input is biased one way or the other. For example, by preventing the user from making (i.e., not registering) a selection until the user leaves the ambiguous state and moves towards the active area or visual area of the button (e.g., click on release). In an embodiment, successive or future attempts at the selection of an element may be adjusted based on a combination of alignment a user's gaze, touch, the active area, and optionally the interaction completion time or dwell time (e.g., dwell time would be the length of time the finger is in contact with a touchscreen before an element is activated).

Optionally, the method 100 may repeat any number of times. For example, the method 100 may be repeated until a predefined environmental context is achieved. If the method is performed by an artificial intelligent agent, repeating the method 100 may improve performance, because the data may be improved. For example, the user may not always be in favor of selection 170 of an element that an artificial intelligence agent may have learned and executed. Thus, the user can freely update it at his wish. This may be done by the user adjusting their behavior so that the artificial intelligence agent learns a new adjustment routine. The agent may also change the learned routine and determine if the changes result in a better or more accurate selection experience for the user (e.g., by learning from an adjustment made in step 164 where the physical area is realigned with an active element of the focused set). This allows the artificial intelligence agent to better learn of the user's behavior from those occasional changes as feedback and may reduce the interaction from the user. This use case may illustrate how the algorithm, e.g., the artificial intelligence agent, may help the user. Since the algorithm itself may be more generic and may learn user behavior based on the data that may lead to the use cases and features.

In a further embodiment, the method 100 may be stored as a program code on a non-transitory, computer-readable medium. The method may then be performed when the program code is executed on a processor.

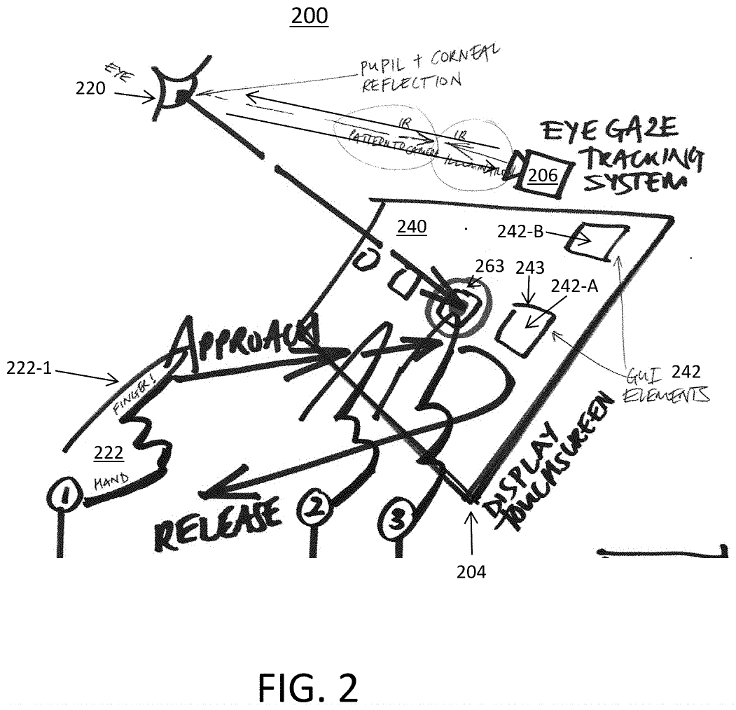

FIG. 2 shows an embodiment of the system 200 for stabilizing a user's interaction with a touchscreen 204. The system may comprise a touchscreen 204, an eye-tracking apparatus 206, and a processor. The processor may be configured to populate an interface 240 of the touchscreen display 204 with a plurality of elements 242. Each element 242-1, 242-2 of the plurality 242 comprises an active area 243 for registering a touch interaction by the user. The processor may then determine a focus area 263 of the user on interface 240. Then compare the focus area 263 with the active areas 243 of the plurality of elements 242 to determine a focused set comprising at least one element that exceeds a selection threshold. The processor further adjusts the active areas 243 of the plurality of elements 242 to increase the selection threshold of at least one element in the focused set.

The eye-tracking apparatus 206 of the system 200 may comprise an infrared camera (IR) or a headset. An infrared camera directs 262 IR illumination onto an eye 202 of a user. The camera then receives 264 an IR pattern that is reflected off the pupil and cornea of the eye. Typically, cameras are IR or near-IR cameras although visible light cameras may also be used. In any camera system, the eye is illuminated with corresponding wavelength light and the system looks for the pupil (which absorbs and does not reflect light and so appears black) and corneal reflection (which reflects light coming from a light source). The system 200 then calculates the vector (i.e., between pupil and corneal reflection). This vector determines the gaze direction and therefore the gaze position on the touchscreen. If a visual light camera is used, the system might use an image or color pattern of the corneal reflection as an error-checking mechanism to confirm that the user is looking at the same image or color pattern presented on the touchscreen.

In another embodiment, the system 200 may use augmented reality or mixed reality (AR or MR) devices, such as AR glasses. In this embodiment, eye tracking may come from a camera located within the glasses. Other inputs may be used to determine the focus area, including physical interactions with touchscreens or touch surfaces (i.e., surfaces that are not a conventional display).

Determining the focus area of the user on the interface 240 may comprise tracking the user's eyes 220 using the eye-tracking apparatus 206 then determining an orientation of the user's eyes 220 with respect to the touchscreen 204. The orientation of the user's eyes 220 may correspond to a first physical location of the touchscreen 204. Determining the focus area may further include measuring a focus time that the user's eyes 220 occupy the orientation and calculating the focus area on the touchscreen 204 based on the orientation of the eyeball and focus time.

An eye-tracking apparatus may be located on or within proximity to the touchscreen. However, the system may be calibrated for various touchscreen and camera configurations throughout a vehicle cabin or other space.

Determining a focus area may further comprise tracking the user's at least one FIG. 222-1 of the user's hand 222 using a finger-tracking apparatus. The orientation of the user's at least one finger corresponds to a second physical location of the touchscreen. Calculating the focus area on the touchscreen based on the orientation of the user's at least one finger. Generally, a user's finger may be a catalyst to centering both their visual attention and cognitive attention (e.g., finding and touching a particular button). Collectively, the body, eye, and finger can reveal a user's mental cognitive attention (i.e., what someone is thinking about). The system 200 may use a combination of proximity, motion, and vector of travel of the finger provides may confirmation, that improves accuracy.

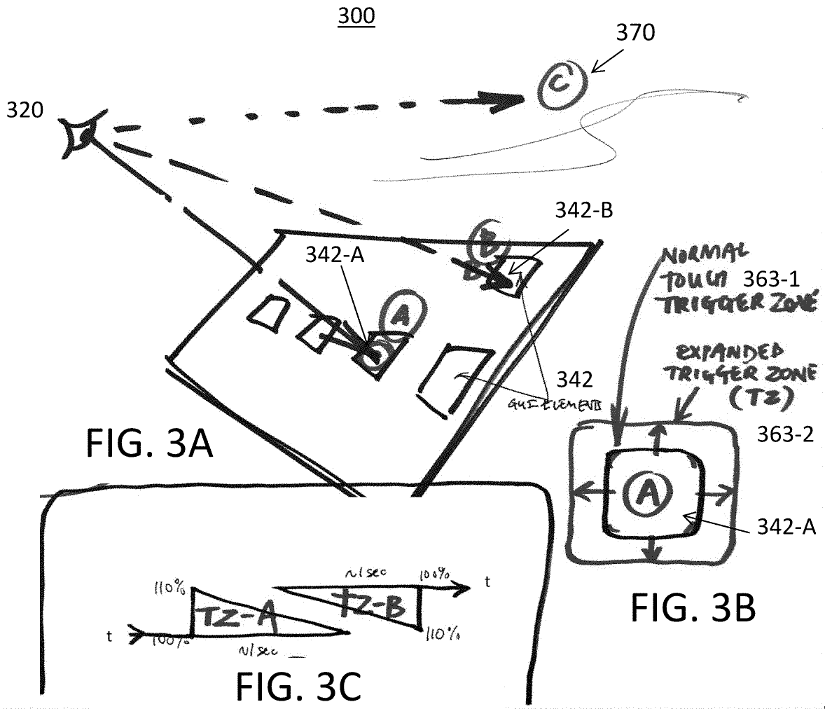

FIGS. 3A to 3C shows an illustrative example of eye gaze tracking between a plurality of interface elements. FIG. 3A shows an example of eye gaze tracking between a first button 342-A and a second button 342.B. The eye or eyes 320 of a user fixates on a first button or GUI element 342-A and then looks at a second button 342-B and then returns their gaze to the first button 342-A. In an embodiment, the active area 363 grows 363-2 and contract 363-1 over a short period (e.g., <1 sec). In this embodiment where the user is deciding between elements 342 and the focus area is split, the system 300 may adjust the trigger zone or active area for the first button 342-A to expand larger or maintain its expanded state for a longer period (e.g., <1.5 secs) than if the focus was split between the first button 342-A and an element off-screen 370. FIG. 3B shows the expansion of the active area or trigger zone (TZ) from its default or normal state 363-1 to an expanded state 363-2.

FIG. 3C shows a graph of how the active areas or trigger zones of two interface elements change over time (t). As eye fixation moves, active areas or trigger zones expand and contract. In an illustrative example, a user fixates on a first button in a first step. Then the active area or trigger zone (TZ-A) for the first button 342-A expands (e.g., from 100% of the button's visual size to 110%). This expansion may be instant or done rapidly. In a second step, the user fixates on a second button 342-B. As the user's fixation moves the active area for the first button 342-A contracts and the active area (TZ-B) for the second button 342-B expands. The expansion of the second button's active area may not be done as rapidly as the first button's active area was expanded but done in proportion to the decline of the first button's active area. The contraction of the first button 342-A may not be immediate or uniform as the system 100 may determine that the user is selecting between two buttons or interface elements and may return to the first button 342-A. In a third step, the user returns their focus to the first button 342-A, and the active area, if it had contracted, expands again. Optionally, the active area of the first button 342-A may expand bigger or for more time based on the user's renewed fixation on the button compared to when the button was focus on for the first time in the first step. FIG. 3B

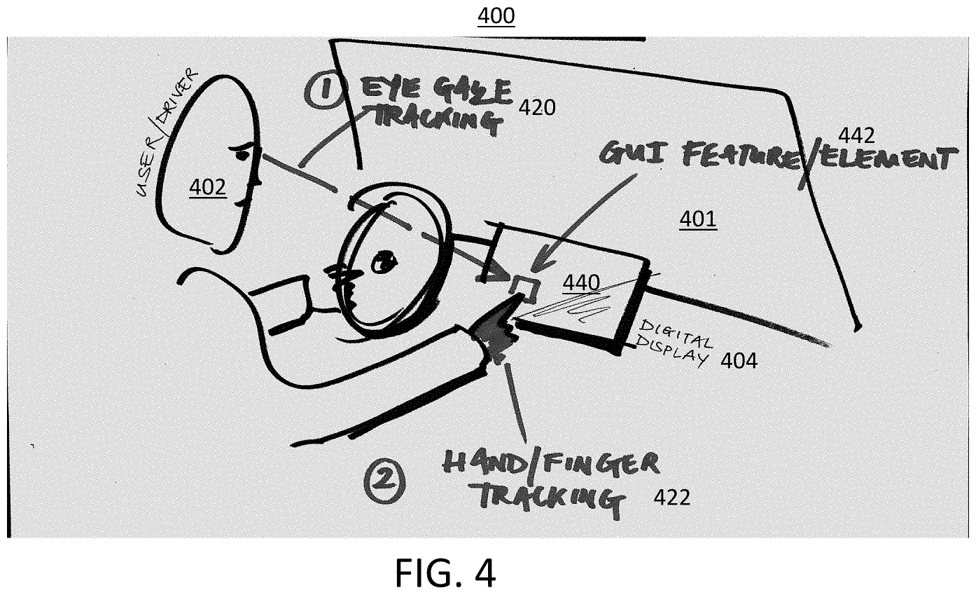

FIG. 4 shows a schematic view of a system 400 for touch stabilization in a vehicle 401. The system may comprise a touchscreen 404, an eye-tracking apparatus, and a processor. The processor may be configured to populate an interface 440 of the touchscreen display 404 with a plurality of elements 442. Each element of the plurality 442 comprises an active area for registering a touch interaction by the user 402. The processor may then determine a focus area of the user on the interface 440. Then compare the focus area with the active areas of the plurality of elements 442 to determine a focused set comprising at least one element that exceeds a selection threshold. The processor further adjusts the active areas of the plurality of elements 442 to increase the selection threshold of at least one element in the focused set.

The system 400 may determine the focus area of the user 402 on the interface by tracking the user's eyes using the eye-tracking apparatus to determine the user's focus or gaze 420, which is determined by measuring an orientation of the user's eyes with respect to the touchscreen 404. The system 400 may further comprise a finger-tracking apparatus, wherein determining a focus area of the user on the interface includes tracking the user's at least one FIG. 422 using the finger-tracking apparatus.

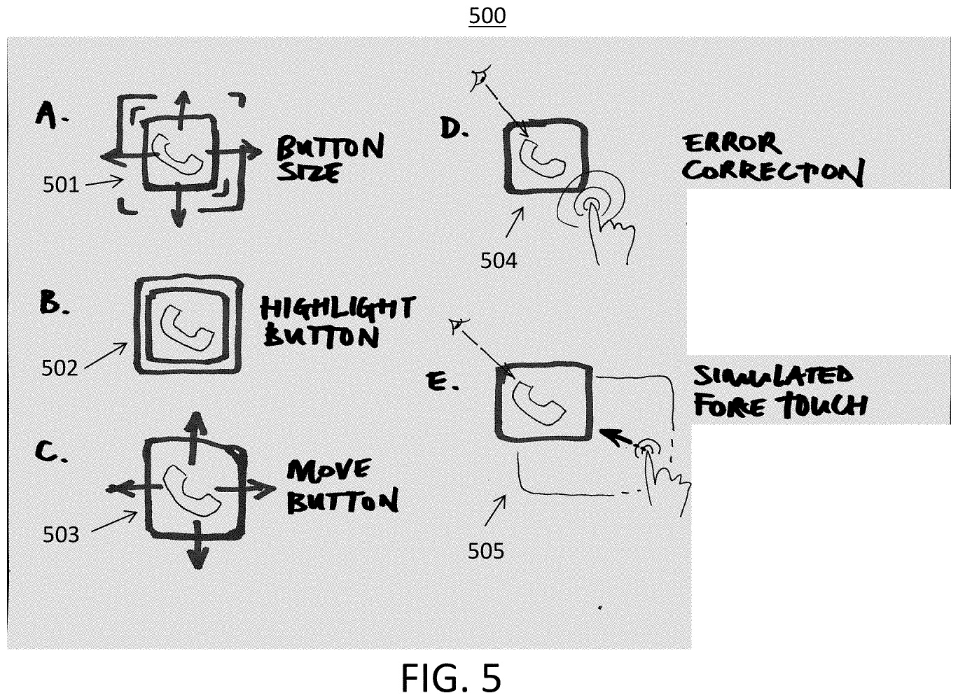

FIG. 5 shows examples of the adaption of elements of a GUI. Adjusting the active or trigger areas may comprise adjusting the size of the active areas 501, visually highlighting the active areas 502, or moving the active areas 503. Additionally, these adjustments may be done to a visual representation of the interface elements themselves. However, expanding the trigger zone and not necessarily expressing it as a visible thing to the user (i.e., trigger zones are invisible to the user) may be less intrusive to the user than visibly highlighting or visibly increasing the size of a button.

Different properties of the interface elements may be adjusted when determining the focus area. Some properties include size, usage, or priority.

With regards to the size of an interface element, for example, the active area of a GUI element may be expanded. However, over-expansion may cause a GUI element, such as a button, to no longer work as a button. The expansion of an active area or trigger zone should be enough to account for a lack of accuracy of precision in the attempted touch. For example, an active area may expand by 5 to 15% or by 3 to 10 mm dependent on the display, button size, or proportions. The adaptation of the active area may be different for different GUI elements, and not uniform for each element. For example, the active area of a slider may be more rectangular in shape than a square button.

With regards to usage, for example, on a music interface, a user may select a location that falls equally between a play/pause button and a skip song button. An embodiment of the method may consider the frequency that each button is pressed to augment the selection of each button. A method may also wait for an ambiguous selection to be resolved. For example, a user may touch and slide their finger towards their fixation (i.e., the convergence of visual, cognitive, and proprioceptive attention) and the method may wait a split second for these to come together. One advantage of the method is that by expanding the trigger zone the time it takes for a user to resolve ambiguity and move or drag their finger toward their fixation would be reduced. FIG. 5 shows the aspect of dragging a finger 505 to an active area. In this embodiment, the system disregards the initial point of touch and allows the finger to travel to the active area to avoid mistouch.

Another method of error correction may involve averaging the physical area with the active areas of the focused set 504 to determine which element of the focused set is the touch target. When a physical interaction is made it may be weighed against the elements of the focused set. For example, if the physical area is within the focused set, it may be weighted highly and cause the selection of the element to be executed. However, if the physical area is outside the focused set its location may be averaged with the focused set to find a third location for selection. For example, this may be the nearest element in the focused set to the physical area, an element halfway between the center of mass of the focused area and the physical area, or some other calculation.

With regards to priority, for example, on a navigation interface, a user may select a location that falls equally between a search and a delete button on a keyboard. An embodiment of the method, in this case, may use the current place in the user's process to augment the selection of each button (e.g., if the user was in the middle of entering an address the delete button may be preferred compared to a search button if a five-digit zip code was entered). In another embodiment, the method 100 may adjust the trigger zones according to the most likely option. For example, the active areas may be expanded in such a way that the delete button requires more touch accuracy and the search button requires less accuracy (e.g., the search button trigger zone expands to overlap the delete button and squeezes/reduces the delete trigger zone)

More than one weighting mechanism may be used to determine how to augment the active or trigger areas of GUI elements. And multiple algorithms can be executed in parallel producing results that would be weighted and used to determine how the active area is modified.

The system may include machine learning that is based on specific users or purely usage patterns of different GUI features. Different users can be differentiated by identifying the user by their car key or smartphone. Particularly if a user uses smart access to unlock a vehicle or pairs their phone paired to a vehicle's computer or entertainment system. A user may also be authenticated via a camera. A machine learning algorithm or artificial intelligence component may require an initial setup procedure that trains the machine on the user's unique interface selection patterns. Inputs of machine learning training may include gaze and figure tracking measurements, dwell time, success rates, interaction, precision, or accuracy metrics.

When retraining a machine learning algorithm, factors may include the amount of trigger zone expansion and time-based contraction as well as the other input metrics (e.g., success rate, dwell time, etc.). Machine learning may be done in the cloud or onboard a vehicle where real-time performance would be increased.

In addition, eye gaze support or the level of eye gaze support may be modified according to experience and success over time. For example, using machine learning to track accuracy and precision over time, this data can be used to increase or decrease the level of eye gaze support. Additionally, using machine learning the GUI content can be optimized (size, location, etc.) to improve accuracy and precision (e.g., by moving frequently used GUI elements/buttons to be closer to the user).

In some embodiments, the system may be coupled to a control module. The control module may be implemented using one or more processing units, one or more processing devices, any means for processing, such as a processor, a computer, or a programmable hardware component being operable with accordingly adapted software. Similarly, the described functions of the control module may as well be implemented in software, which is then executed on one or more programmable hardware components. Such hardware components may comprise a general-purpose processor, a Digital Signal Processor (DSP), a micro-controller, etc.

In an embodiment, the system may comprise a memory and at least one processor operably coupled to the memory and configured to perform the above-mentioned method.

Any of the proposed methods may be implemented on a computer. The method may be stored as instructions for a computer or other apparatus on a non-transitory, computer-readable medium. When the medium is read by a computer, the method may be performed or executed by the computer or any apparatus networked with the computer. A computer-implemented method may provide a reinforcement-learning-based algorithm to autonomously learn user behavior under a different context. The method may do not need supervised annotation data and can efficiently and automatically learn on a small set of data adaptively. It may be getting more useful when dealing with a sequence of decisions and actions that may be a common usage scenario but distracting the user's attention.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or another programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. A method for stabilizing a user's interaction with a touchscreen, the method comprising:
populating an interface of the touchscreen display with a plurality of elements,
wherein an element of the plurality comprises an active area for registering a touch interaction by the user;
determining a focus area of the user on the interface;
comparing the focus area with the active areas of the plurality of elements to determine a focused set comprising at least one element that exceeds a likely selection threshold;
adjusting the active areas of the plurality of elements to reduce the likely selection threshold of the at least one element in the focused set.

2. The method of claim 1 further comprising:
determining a physical area corresponding with the user's interaction with the touchscreen, and
determining a touch target by comparing the physical area with the active areas of the focused set,
selecting one of the plurality of elements based on the touch target.

3. The method of claim 2 wherein determining the touch target comprises:
averaging the physical area with the active areas of the focused set to determine which element of the focused set is the touch target.

4. The method of claim 2 determining the touch target comprises:
delaying selection of the touch target until the physical area is realigned with an active element of the focused set.

5. The method of claim 1 wherein adjusting the active areas comprises one of:
adjusting the size of the active areas,
moving the active areas, or
visually highlighting the active areas.

6. The method of claim 1 wherein determining a focus area comprises:
tracking the user's eyes using an eye-tracking apparatus,
determining an orientation of the user's eyes with respect to the touchscreen,
wherein the orientation of the user's eyes corresponds to a first physical location of the touchscreen,
measuring a focus time that the user's eyes occupy the orientation,
calculating the focus area on the touchscreen, wherein the calculation includes the orientation of the eyeball and the focus time.

7. The method of claim 6, wherein determining a focus area further comprises:
tracking the user's at least one finger using a finger-tracking apparatus, wherein the orientation of the user's at least one finger corresponds to a second physical location of the touchscreen,
calculating the focus area on the touchscreen, wherein the calculation further includes the orientation of the user's at least one finger.

8. The method of claim 7 further comprising calculating the focus area on the touchscreen until a physical area corresponding with the user's interaction with the touchscreen is determined.

9. A system for stabilizing a user's interaction with a touchscreen, the system comprising:
a touchscreen,
an eye-tracking apparatus,
a processor configured to:
populate an interface of the touchscreen display with a plurality of elements,
wherein an element of the plurality comprises an active area for registering a touch interaction by the user;
determine a focus area of the user on the interface;
compare the focus area with the active areas of the plurality of elements to determine a focused set comprising at least one element that exceeds a selection threshold;
adjust the active areas of the plurality of elements to increase the selection threshold of the at least one element in the focused set.

10. The system of claim 9 wherein the eye-tracking apparatus comprises:
an infrared camera,
a headset,

11. The system of claim 9 wherein determining the focus area of the user on the interface comprises:
tracking the user's eyes using the eye-tracking apparatus,
determining an orientation of the user's eyes with respect to the touchscreen,
wherein the orientation of the user's eyes corresponds to a first physical location of the touchscreen,
measuring a focus time that the user's eyes occupy the orientation,
calculating the focus area on the touchscreen based on the orientation of the eyeball and focus time.

12. The system of claim 9 further comprising a finger-tracking apparatus, wherein determining a focus area of the user on the interface
tracking the user's at least one finger using the finger-tracking apparatus,
wherein the orientation of the user's at least one finger corresponds to a second physical location of the touchscreen,
calculating the focus area on the touchscreen based on the orientation of the user's at least one finger.

13. A non-transitory, computer-readable medium storing a program code for performing the method of claim 1 when the program code is executed on a processor.
